(19) United States
(12) Patent Application Publication
(10) Pub. No.: US 2025/0307016 A1
(43) Pub. Date: Oct. 2, 2025

(54) ALLOCATING ACCESS ACROSS DISTRIBUTED COMPUTING RESOURCES

(71) Applicant: JP Morgan Chase Bank, N.A., New York, NY (US)

(72) Inventor: Bryan LANG, Maricopa, AZ (US)

(73) Assignee: JP Morgan Chase Bank, N.A., New York, NY (US)

(21) Appl. No.: 18/617,180

(22) Filed: Mar. 26, 2024

(51) Int. Cl. G06F 9/50; G06F 9/455

(52) U.S. Cl. CPC G06F 9/5044; G06F 9/45558; G06F 9/5077; G06F 2009/45579; G06F 2009/45583

(57) ABSTRACT

There are provided systems and methods for minimizing total emissions during distributed processing. For example, there is provided a method residing as instructions on a non-transitory computer-readable medium. The instructions are configured to cause a processor to perform certain operations. The operations can include receiving a request for access to a resource, and determining, based on the request, a usage profile. The operations may further include executing, based on the usage profile, a search for an available resource corresponding to one or more attributes of the usage profile. Furthermore, the operations may include, in response to finding the available resource, providing access to the available resource, tracking a plurality of parameters associated with the available resource upon the available resource being used after the providing.

### TECHNICAL FIELD

The present disclosure relates to distributed computing. More particularly, the present disclosure relates to distributed computational processes.

### BACKGROUND

Conventional networked computers and devices send transactions to a centralized location (e.g., a data center) for processing, computing, and execution. Subsequently, the data center performs requested tasks, but also generates heat and consumes electricity. After task execution, the central location sends the results to the requesting party. In this paradigm, and using conventional approaches, the cost of execution and performance are independent of any external conditions. In other words, in this paradigm, tasks are executed without considering parameters like cost, location, latency, or the requesting party's acceptable performance level in executing a task.

By way of example, conventional networked computer data centers can have enormously high power demands. As a result, these data centers also possess correspondingly high cooling capabilities that can efficiently transfer the heat produced during operation. Although the power demands may be high during peak periods of operation, the majority of the time these networked computers and computing resources are sitting idle. There are limited means to optimize the use of these computing resources in ways that not only leverage their computational capability but can also efficiently utilize their byproducts. For example, these conventional systems lack the ability to autonomously and maximally use the data centers located in environmentally colder physical locations that may benefit from the transferred heat.

### SUMMARY

Given the aforementioned deficiencies, there is a need for optimized networking and computing paradigms to provide more efficient usage of network resources while minimizing cost and environmental impact. Conventional computational hardware has a limited input cache and performs its processes as soon as possible, independent of any other factors. A computation is requested, performed, and results returned, without any time consideration other than how fast the hardware can process the query.

The embodiments featured herein help solve or mitigate the above-noted deficiencies as well as other issues known in the art.

One illustrious embodiment provides the means to distribute the computing load of the network based on a multitude of society-benefiting criteria with selectable priority. Consider the example of a winter storm causing electricity prices in Delaware (DE) to skyrocket at the same time the sun is fully shining on a solar farm co-located with a data center in Colorado (CO). In this example, the embodiments can automatically shift processing loads bound for DE to CO because the power is cheaper and may also have a lower emissions factor than the originally destined DE data center.

Similarly, this process would allow for burdening a data center experiencing more efficient cooling, so the cost of energy per transaction is lower because the computing hardware is more cheaply cooled than elsewhere on the network.

Under certain circumstances, the embodiments featured herein provide a method residing as instructions on a non-transitory computer-readable medium, the instructions being configured to cause a processor to perform certain operations. The operations can include receiving a request for access to a resource, and determining, based on the request, a usage profile. The operations may further include executing, based on the usage profile, a search for an available resource corresponding to one or more attributes of the usage profile.

Furthermore, the operations may include, in response to finding the available resource, providing access to the available resource, tracking a plurality of parameters associated with the available resource upon the available resource being used after the providing. Moreover, the operations may further include, based on the tracking, comparing the plurality of parameters to parameters from a baseline profile and training a model for the search based on the comparing, the search to be affected using the model upon receiving a subsequent request.

Another embodiment provides a system comprising a processor and a memory that includes instructions stored thereon. When executed by the processor, the instructions may cause the processor to perform certain operations. The operations can include receiving a request for access to a resource, and determining, based on the request, a usage profile. The operations may further include executing, based on the usage profile, a search for an available resource corresponding to one or more attributes of the usage profile. Furthermore, the operations may include, in response to finding the available resource, providing access to the available resource, tracking a plurality of parameters associated with the available resource upon the available resource being used after the providing. Moreover, the operations may further include based on the tracking, comparing the plurality of parameters to parameters from a baseline profile and training a model for the search based on the comparing, the search to be affected using the model upon receiving a subsequent request.

Yet another embodiment provides a non-transitory computer-readable medium having instructions stored thereon. When the instructions are executed by a processor, they cause the processor to perform a method comprising certain operations. The operations can include receiving a request for access to a resource, and determining, based on the request, a usage profile. The operations may further include executing, based on the usage profile, a search for an available resource corresponding to one or more attributes of the usage profile. Furthermore, the operations may include, in response to finding the available resource, providing access to the available resource, tracking a plurality of parameters associated with the available resource upon the available resource being used after the providing. Moreover, the operations may further include based on the tracking, comparing the plurality of parameters to parameters from a baseline profile and training a model for the search based on the comparing, the search to be affected using the model upon receiving a subsequent request.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for the purpose of illustrating the embodiments and are not to be construed as limiting the disclosure. Given the following enabling description of the drawings, the novel aspects of the present disclosure should become evident to a person of ordinary skill in the relevant art(s).

FIG. 1 illustrates a conventional computational resource distribution network.

FIG. 2 illustrates a computational resource distribution network according to several embodiments of the present disclosure.

FIG. 3 illustrates an exemplary method according to several embodiments of the present disclosure.

FIG. 4 is an example illustration of a single resource distribution model according to the embodiments.

FIG. 5 is an example implementation of a single resource distribution model according to the embodiments.

FIG. 6 illustrates the tuning of the single resource distribution model of FIG. 4 in response to the predictions illustrated in FIG. 5.

FIG. 7 illustrates a process using a series of maps to analyze the highest value assets in time against a larger population of assets.

FIG. 8 illustrates a system according to several aspects of the present disclosure.

### DETAILED DESCRIPTION

While the illustrative embodiments are described herein for particular applications, it should be understood that the present disclosure is not limited thereto. Those skilled in the art and with access to the teachings provided herein will recognize additional applications, modifications, and embodiments within the scope thereof and additional fields in which the present disclosure would be of significant utility.

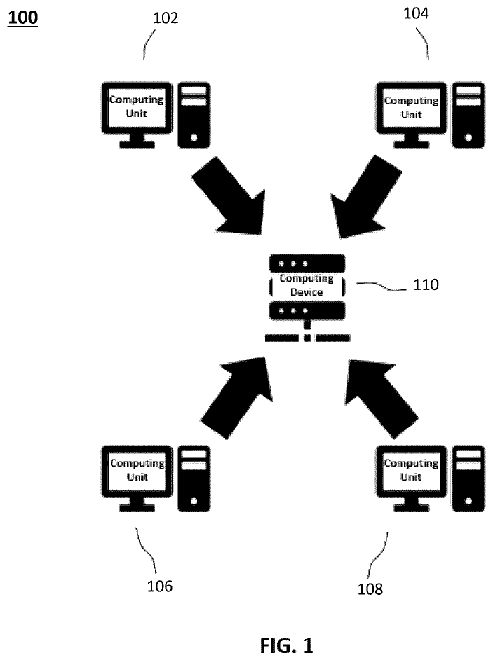

FIG. 1 illustrates a typical network 100. The network 100 may include a plurality of computing units (102, 104, 106, and 108). Here, these units are illustrated as typical desktop computers by way of example only. Generally, in the network 100, computing units may take one of a wide variety of formats known to one of ordinary skill in the art. For example, and not by limitation, computing units 102, 104, 106, and 108 each may be one of a server, an embedded computer system, a virtual machine, a desktop computer, and generally, any other device (including software and/or hardware components) that may be configured to provide computing services. Furthermore, the network 100 does not require that all the computing units be the same. In other words, the network 100 may have a set of disparate computing units. The network 100 further includes a computing device 110 which may be configured to be accessible by other computing units in the network. Again, the computing device 110 may be of any format known to one of ordinary skill in the art.

In typical network and distributed computing enabled by the network 100, the computing device 110 serves a central node in the network where all the other computing units can connect (as indicated by the arrows) to request resources provided by the computing device 110. For example, the computing unit 102 may request access to a virtual machine provisioned and maintained by the computing device 110. In yet another example, the request may be to access a virtual desktop application. In yet another example, the request may be to access computing resources of the computing device 110 to manipulate large datasets which may be located in another node in the network 100 (i.e., at any other computing unit in the network).

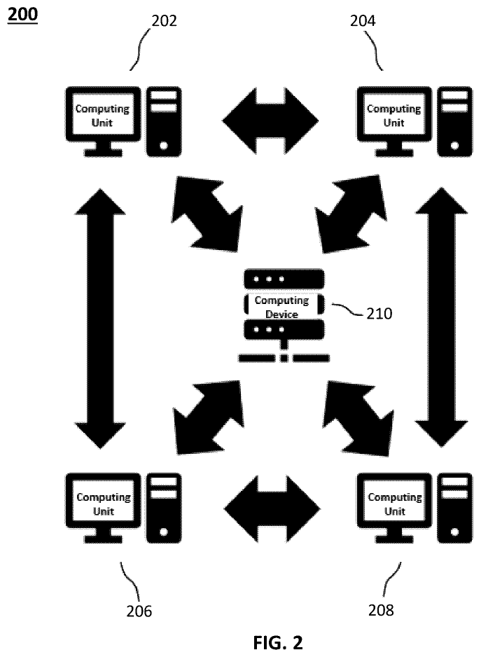

FIG. 2 illustrates a network 200 according to one embodiment. The network 200 may include a plurality of computing units (202, 204, 206, and 208). Here, these units are illustrated as typical desktop computers by way of example only. Generally, in the network 200, computing units may take one of a wide variety of formats known to one of ordinary skill in the art. For example, and not by limitation, computing units 202, 204, 206, and 208 each may be one of a server, an embedded computer system, a virtual machine, a desktop computer, and generally, any other device (including software and/or hardware components) that may be configured to provide computing services.

Furthermore, the network 200 does not require that all the computing units be the same. In other words, the network 200 may have a set of disparate computing units. The network 200 further includes a computing device 210 which may be configured to be accessible by other computing units in the network.

However, unlike in the typical network 100, the network 200 may include an embodiment to decentralize computing and resource utilization in order to minimize the cost of execution. Here, cost may refer to any one of monetary cost, power consumption, heating load, and latency. Generally, any parameter that is involved in performing a task may be considered as a cost, and that parameter may be optimized according to the teachings provided herein. For example, in the network 200, networked computers and devices may send transactions to an optimal location for processing, computing, and execution.

In the network 200, the most optimized location is selected for one or more requests, according to one or more cost parameters, or generally, according to a cost function. Once the task is completed at the optimized location, the results of the tasks are sent back to the requesting device. As such, in contrast to the network 100, the network 200 decentralizes and optimizes computing. As indicated by the arrows, single computing units 202, 204, 206, and 208 can request access to a computing device 210 but may serve as locations for task execution.

Generally, in the network 200, there are provided methods and systems that distribute loads to computing resources based on several factors whose priority is variable and assignable. Such factors may include, by example and not by limitation, PUE, the need for heat, power cleanliness (which is inclusive of onsite solar over-generation, hourly grid emissions factors, or building-level battery reserves), power cost, energy cost, computing capacity available, urgency of request (which is inclusive of the monetary value associated with request, time sensitivity, or the type of request), expected computing resources required, cache requirements, expected turn-around time, etc.

These methods and systems offer reduced fuel consumption, lower costs, lower emissions, and greater resiliency via the automatic transfer of transactional loads to the most beneficial resources.

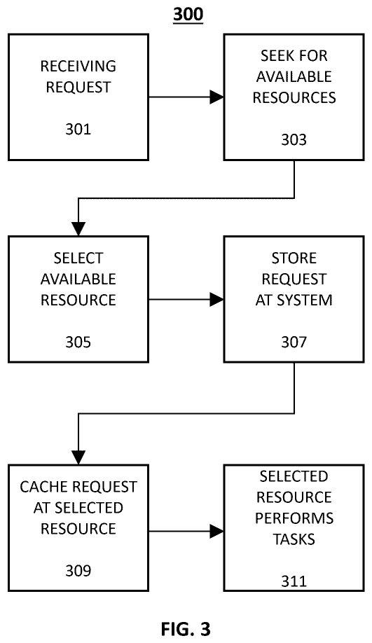

FIG. 3 illustrates an exemplary method 300, according to an embodiment. The method 300 may be implemented as instructions stored on a non-transitory computer-readable medium and executed by an application-specific processor. The method 300 may be executed at any one computing unit of the network 200 or at the computing device 210. Where it is executed, the executing device forms a system that distributes load and minimizes costs according to variables that are assigned a cost value.

The method 300 begins at block 301 where a request is received by the system. Here, for example, and not by limitation, the request may be for the usage of a resource in the network or for the usage of compute resources to process a large quantity of data. Upon receiving the request, the system may seek available resources at block 303 and subsequently select an available resource at block 305, based on the request, the cost associated with the request, and the available resources in the network 200.

The request may be stored at the system 307. There, it may serve as a means to learn and build analytics about the requesting party, using artificial intelligence (AI) or machine learning (ML) techniques. These analytics can anticipate the needs of the requesting party in a future instance, which may optimize the finding of a suitable resource. Following this block, the request is cached at the selected resource (block 309) for further learning as well. As block 311, the selected resource performs tasks associated with the request.

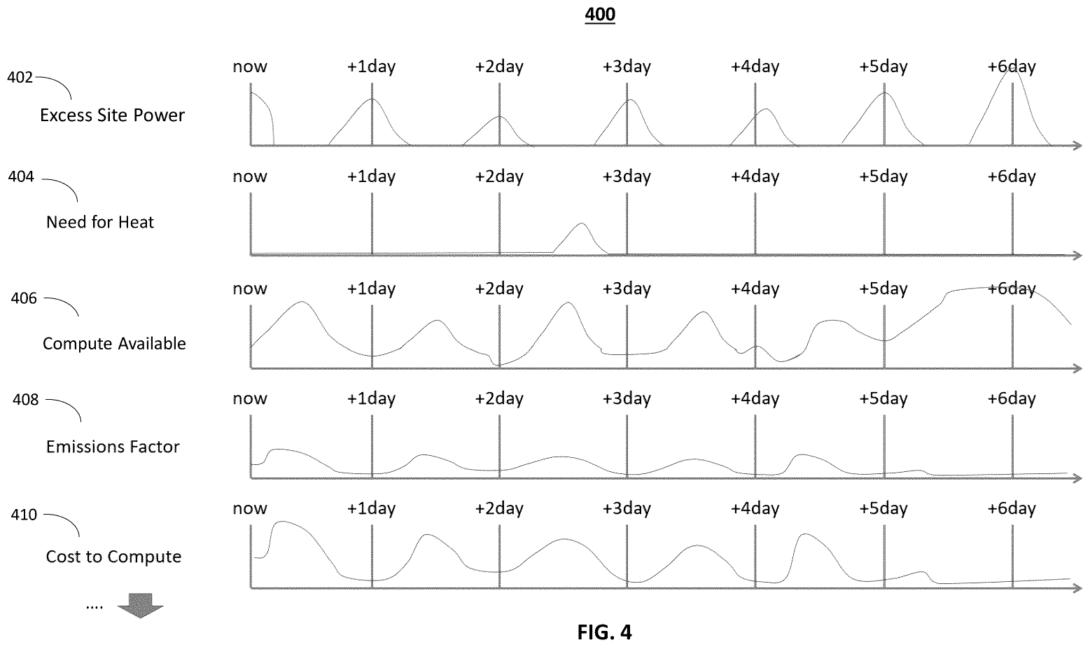

FIG. 4 is an example illustration of a single resource model 400 according to the embodiments. The resource model 400 is a framework configured to model the benefits of computer computational resources being distributed at various times as a function of interdependent, dynamic, and predictable resource variables, in accordance with the embodiments.

For example, daily excess site power 402 may be tracked via a utility meter in relation to an individual's home or an office building. The building's daily need for heat 404 might be tracked through office automation engaged with a heating, ventilation, and air conditioning (HVAC) system. Daily available computational power 406 of the individual's computer may be monitored as well as a daily emissions factor 408 of the electric grid. A daily cost to compute 410 may represent a compilation of various factors associated with the total costs of performing the required computing. Activity lines 402a-410a represent a prediction of the future activity levels (over time) of each of the resource variables 402-410, respectively.

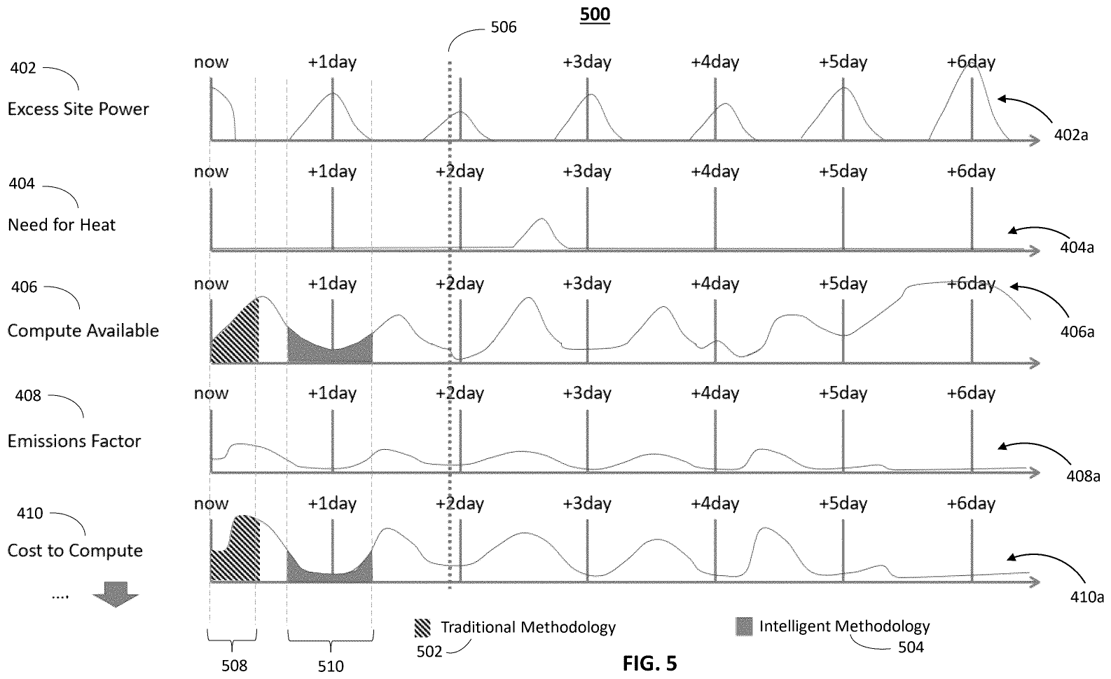

FIG. 5 is an example illustration of the single resource model 400 of FIG. 4 depicting control request restraint overlays 500. One of the overlays is a computational resource restraint based on traditional distribution methodology 502. The other overlay 500 is a computational resource restraint based on an intelligent distribution methodology 504, in accordance with the embodiments. In the example of FIG. 5, the traditional and intelligent methodologies 502 and 504 respectively, must be completed by deadline 506 (e.g., a Friday afternoon).

By way of example, the traditional distribution methodology 502 may include a request for processing (i.e., resource distribution) submitted to a central computer for execution. The computer will prioritize and process the request immediately (i.e., absent any optimization modeling), independent of any other factors. Within time window 508, and consistent with the predicted activity lines 402a-410a, the traditional distribution methodology 502 is processed in a suboptimal manner.

For example, by immediately processing the request for computational resources, the traditional distribution methodology 502 is processed when the cost to compute 410, the electric grid emissions factor (e.g., carbon emissions) 408, and the compute available 406 are at peak levels (e.g., most costly). Additionally, the traditional distribution methodology 502 would process the request when the need for heat 404 and excess site power 402 are essentially zero. Ideally, the computational resources would be distributed when the excess site power 402 is high, which could offset the high cost to compute 410. However, as stated earlier, the traditional distribution methodology 502 is processed independently of any other factors and without consideration for potential optimization. The only priority is completion before the deadline 506.

By contrast, the intelligent distribution methodology 504 leverages the benefits of optimization modeling. That is, the intelligent distribution methodology 504 triggers an analysis of each of the resource variables 402-410, based on the respective activity lines 402a-410a, such that processing of the distribution request can occur most optimally. In FIG. 5, for example, the intelligent distribution methodology 504 is modeled for processing during time window 510.

During time window 510, there would be an excess of site power 402 and the need for heat 404 would be substantially zero. The time window 510 also occurs when the compute available 406 is minimal and the emissions factor 408 is at its lowest level. The time window 510 would represent an example of where emissions are prioritized. In this example, the costs would be low because there is excess site power 402, resulting in virtually free use, from the standpoint of utilities. The time window 510 would also be the cheapest (lowest cost to compute 410) time for processing the computational resource distribution request. Further, the time window 510 would occur during the lowest carbon-emitting timeframe and would be completed before the deadline 506.

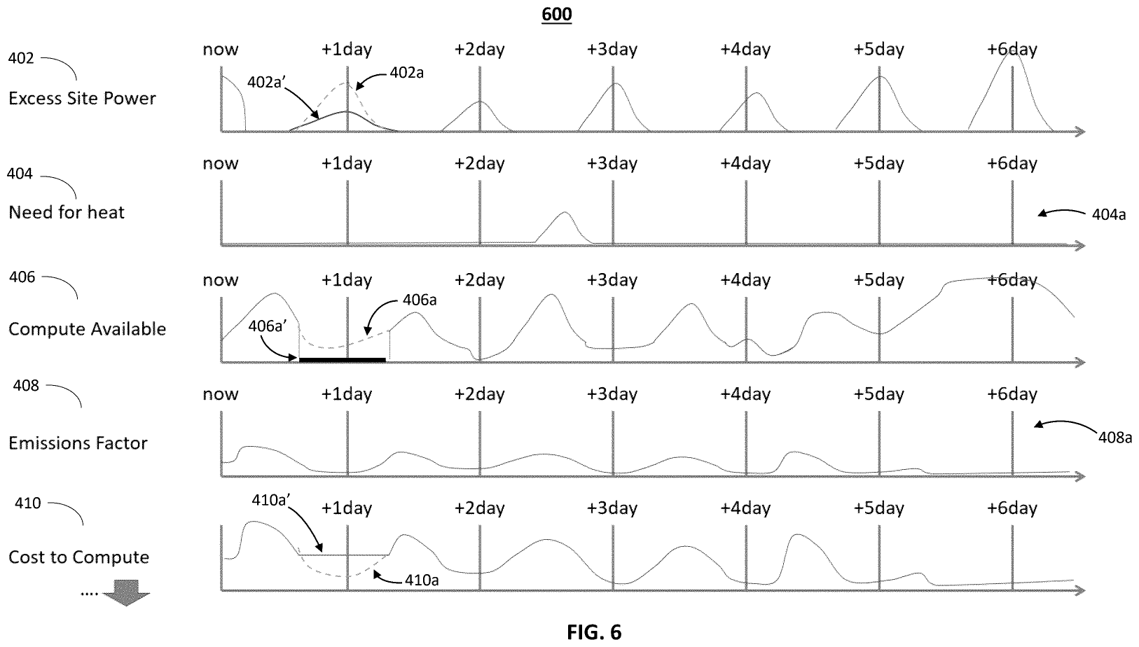

Based on the modeled predicted benefits above of distributing the computational resources during the time window 510, the request to distribute this resource would not be processed to occur immediately. Instead, the request would be cached, such that processing would occur at a later time: during the time window 510. Based on the intelligent distribution methodology 504, the underlying math of predicting the future behavior of the resource variables 402-410 would be adjusted and the resource model 400 would be updated, as illustrated in FIG. 6.

FIG. 6 illustrates graph 600 depicting the tuning of the single resource distribution model of FIG. 4 in response to the predictions illustrated in FIG. 5. In graph 600, the levels associated with the resource variables 402-410 are adjusted to accurately reflect the available resources in response to processing the computational capability distribution request. For example, processing the computational resource distribution request during the time window 510 would reduce the amount of excess site power 402 reflected in the initial level of the activity lines 402a. A new activity line 402a′ reflects a dip in the level of excess site power 402a in comparison to the initial activity line 402a.

Corresponding adjustments in levels of the compute available 406 and the cost to compute 410 are reflected in new activity lines 406a′ and 410a′ respectively in comparison to initial activity lines 406a and 410a.

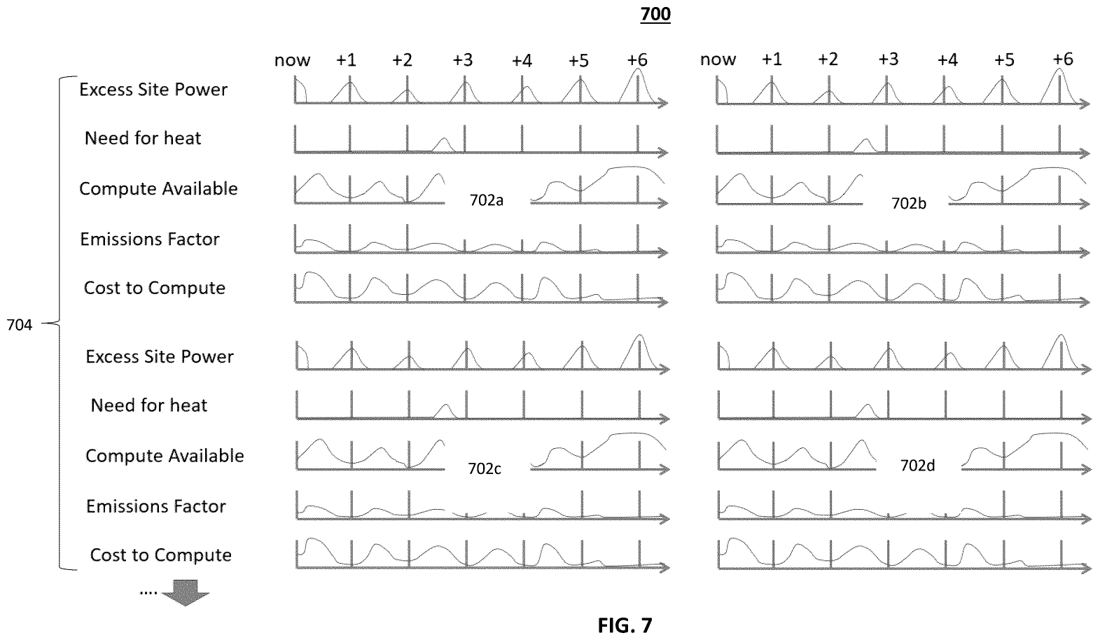

FIG. 7 illustrates a process 700 using a series of maps 702a-702d to analyze the highest value asset in time against a larger population of all available resources 704. By way of example, process 700 would analyze all of the maps 702a-702d simultaneously to find kind of a local minimum of costs and emissions, which would translate to maximum value. During process 700, the computer would select which resource(s) to use to satisfy the user's request.

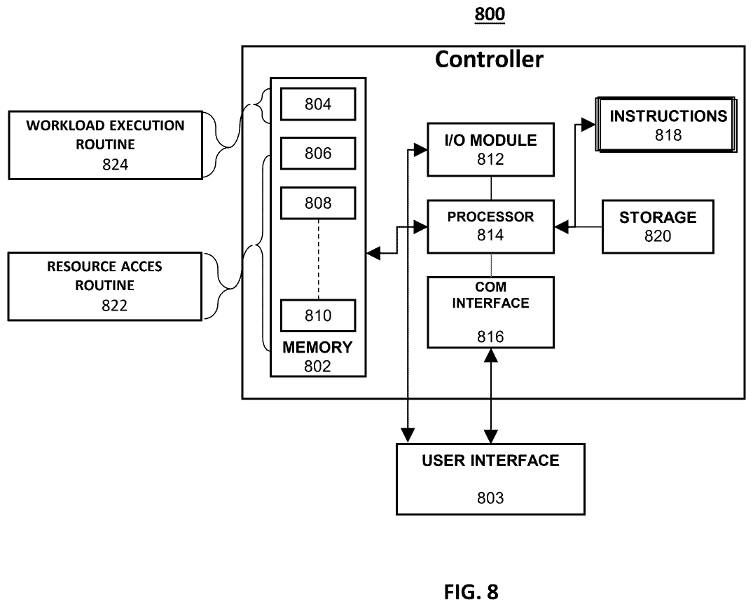

FIG. 8 describes an exemplary computer controller 800 configurable to execute the various methods and processes described above. In controller 800, each or all of the various methods described herein, such as the entitlement group, may be embodied in the controller 800. For example, the various methods may be embodied as instructions residing in a non-transitory component such as a memory or a storage device associated with the controller 800. That is, the structure of the controller 800 is imparted to it by the methods described herein in the form of instructions.

The controller 800 may be an application-specific hardware, software, and firmware implementation (or a combination thereof) configured to execute the exemplary methods described herein. The controller 800 may also represent a structural and application-specific implementation of the other exemplary systems described herein. The controller 800 can include a processor 814 configured to execute one or more, or all of the blocks of the exemplary methods described previously.

The processor 814 can have a specific structure imparted thereto by instructions stored in a memory 802 and/or by instructions 818 fetchable by the processor 814 from a storage medium 820. The storage medium 820 may be co-located with the controller 800 as shown, or it can be remote and communicatively coupled to the controller 800. Such communications may be encrypted.

The controller 800 may be a stand-alone programmable system, or a programmable module included in a larger system. For example, the controller 800 can be included as part of an environment provider infrastructure. Also, the controller 800 may include one or more hardware and/or software components configured to fetch, decode, execute, store, analyze, distribute, evaluate, and/or categorize information.

The processor 814 may include one or more processing devices or cores (not shown). In some embodiments, the processor 814 may be a plurality of processors, each having either one or more cores. The processor 814 can execute instructions fetched from the memory 802, i.e., from one of memory modules 804, 806, 808, or 810. Alternatively, the instructions can be fetched from the storage medium 820, or from a remote device connected to the controller 800 via a communication interface 816. An input/output (I/O) module 812 may be configured for additional communications to or from remote systems or to a user interface 803 from which the processor 814 may receive a set of requirements. Such additional communications may be facilitated by a communication interface 816.

Without loss of generality, the storage medium 820 and/or the memory 802 can include a volatile or non-volatile, magnetic, semiconductor, tape, optical, removable, non-removable, read-only, random-access, or any type of non-transitory computer-readable computer medium. The storage medium 820 and/or the memory 802 may include programs and/or other information usable by processor 814, such as for example, instructions that enable the processor 814 to execute the cloud environment access methods described herein. Furthermore, the storage medium 820 can be configured to log data processed, recorded, or collected during the operation of the controller 800.

The data may be time-stamped, location-stamped, cataloged, indexed, encrypted, and/or organized in a variety of ways consistent with data storage practice. By way of example, the memory modules 804 to 810 can form instructions that embody a method for providing access to a remote resource while minimizing total emissions.

In other words, the memory modules 804 to 810 may form a resource access routine 822 that can cause processor 814 to perform certain operations upon execution. For example, the operations can include receiving a request for access to a resource and determining, based on the request, a usage profile. The operations may further include executing, based on the usage profile, a search for an available resource corresponding to one or more attributes of the usage profile. Furthermore, the operations may include, in response to finding the available resource, providing access to the available resource, and tracking a plurality of parameters associated with the available resource upon the available resource being used after the providing. Moreover, the operations may further include based on the tracking, comparing the plurality of parameters to parameters from a baseline profile and training a model for the search based on the comparing, the search to be affected using the model upon receiving a subsequent request.

In addition to the routine 822, the memory 802 may include instructions that cause the processor 814 to provision for the execution of a workload while minimizing total emissions. These instructions may form a routine 824, which may cause the processor to perform certain operations when executed. The operations can include receiving a request, the request being associated with a batch process for manipulating a dataset. The operations can further include receiving a deadline by which the request must be executed and evaluating a set of requirements for executing the request by the deadline. The operations can further include entering the request into a queue, where the queue is associated with a hardware location that physically hosts the dataset. The operations can further include determining an optimum time within the deadline for executing the request.

The teachings featured herein are now described generally in the context of exemplary use cases and general embodiments. For example, in one exemplary use case, a system of the present disclosure may be used to provide a remote desktop session. For example, a user in New York City on a cloudy day, for example, and not by limitation, may enter their remote desktop credentials at a terminal, selecting “log on.” The system may then check the user's typical usage profile, and it may determine the user is a “light user” and that they would not notice or would not be bothered by a specified amount of latency. It is noted that a “user” here may be a human entity, or generally, another machine communicatively coupled to the system and that is capable of requesting access to one or more resources, the access being granted and provisioned by the system.

The system then looks at the available compute resources across a network that it is communicatively coupled to and finds a capable machine that is unlikely to be used during the present user's session. For example, and not by limitation, the capable machine may be physically located in Arizona at a facility that is over-generating solar power from its onsite panels, and the over-generation will last for the majority of the user's session. The system then selects that machine to host the virtual desktop session and it launches, opening the virtual desktop session to the user.

The system then tracks parameters like cost, power, emissions, latency, and compute loading, of the session and compares it to a baseline profile, compiling the impacts of the choice made and comparing the results to a strategic profile, which may be, for example and not by limitation, set by a network administrator. Furthermore, the above-noted parameters are not the only parameters that may be tracked; one of ordinary skill in the art will readily recognize that tracked parameters may include any other metric that is associated with computing or compute resource usage. At the end of the session, the user may be prompted with a survey, and data from the survey may be used to further train a model for finding available resources across the network when the system receives a subsequent request for using a resource.

The feedback solicited in the survey may be, for example, and not by limitation, parameters such as impact to work, wait time, and loading time. Again, generally, any parameter associated with computing or compute resource usage may be solicited, not just the ones listed above. Lastly, results are analyzed based on the projections made at the start of the session, and the user's typical use profile and the system's selection criteria are updated to optimize the next execution of this instance.

In yet another exemplary use case, an embodiment (e.g., one of the aforementioned exemplary systems) may provide a workflow for database manipulation. For instance, a user may construct a batch process to manipulate a large amount of data. Upon finalizing the request and submitting it to an exemplary system disclosed herein, the user may be prompted for processing criteria such as a time for which the request must be executed, and the associated workload completed. One of ordinary skill in the art will readily recognize that other criteria may be prompted for, without departing from the teachings of the present disclosure. The system may store the received command, and it may evaluate the data location and processing requirements like the time to complete the workload associated with the request.

Subsequently, the system may enter the request into a queue for a hardware location that physically hosts the data requested to be committed such the actual compute work will be done at an optimum time. For example, and not by limitation, an optimum time may be in the middle of the night when power is cheapest, and when asset loading and heat rejection are optimal. This way, the workload may be completed with the most value. Once the workload is completed, the system may review and revise its predictions of the process compared to the actual results measured. Subsequently, the system may adjust its extrapolation factors concerning that type of request and the location asked to perform the work. The system may also quantify parameters like cost, power, emissions, latency, and compute loading associated with executing the request. Then, the system may compare these parameters to that of a baseline profile, compiling the impacts of the choice that was made and comparing the results to a strategic profile, which may be, for example, and not by limitation, set by a network administrator.

In addition to the aforementioned exemplary use cases, there are provided below descriptions of several general embodiments. For example, one embodiment provides a method residing as instructions on a non-transitory computer-readable medium, the instructions being configured to cause a processor to perform certain operations. The operations can include receiving a request for access to a resource and determining, based on the request, a usage profile. The operations may further include executing, based on the usage profile, a search for an available resource corresponding to one or more attributes of the usage profile. Furthermore, the operations may include, in response to finding the available resource, providing access to the available resource, and tracking a plurality of parameters associated with the available resource upon the available resource being used after the providing. Moreover, the operations may further include based on the tracking, comparing the plurality of parameters to parameters from a baseline profile and training a model for the search based on the comparing, the search to be affected using the model upon receiving a subsequent request.

The available resource may be a networked resource. Furthermore, the operations can include providing the available resources includes estimating the likelihood of the available resource being unused for at least a typical usage time included in the usage profile. The plurality of parameters can include at least one parameter selected from the set of parameters consisting of: cost, power, emissions, latency, and compute loading. The resource and the available resource may each be a virtual machine. Moreover, providing the available resource may include selecting the available resource based on a power generation level associated with the available resource. Furthermore, the power generation level is an over-power generation level.

Another embodiment provides a non-transitory computer-readable medium having instructions stored thereon. When the instructions are executed by a processor, they cause the processor to perform a method comprising certain operations. The operations can include receiving a request for access to a resource and determining, based on the request, a usage profile. The operations may further include executing, based on the usage profile, a search for an available resource corresponding to one or more attributes of the usage profile. Furthermore, the operations may include, in response to finding the available resource, providing access to the available resource, tracking a plurality of parameters associated with the available resource upon the available resource being used after the providing. Moreover, the operations may further include based on the tracking, comparing the plurality of parameters to parameters from a baseline profile and training a model for the search based on the comparing, the search to be affected using the model upon receiving a subsequent request.

The available resource may be a networked resource. Furthermore, the operations can include providing the available resource and estimating the likelihood of the available resource being unused for at least a typical usage time included in the usage profile. The plurality of parameters can include at least one parameter selected from the set of parameters consisting of: cost, power, emissions, latency, and compute loading. The resource and the available resource may each be a virtual machine. Moreover, providing the available resource may include selecting the available resource based on a power generation level associated with the available resource. Furthermore, the power generation level is an over-power generation level.

Another embodiment provides a method residing as instructions on a non-transitory computer-readable medium, the instructions being configured to cause a processor to perform certain operations. The operations can include receiving a request, the request being associated with a batch process for manipulating a dataset. The operations can further include receiving a deadline by which the request must be executed and evaluating a set of requirements for executing the request by the deadline. The operations can further include entering the request into a queue, where the queue is associated with a hardware location that physically hosts the dataset. The operations can further include determining an optimum time within the deadline for executing the request.

The optimum time may be a time at the hardware location when power is cheapest. Furthermore, the optimum time may be a time at the hardware location where asset loading is optimal. Furthermore, the optimum time may be a time at the hardware location where heat rejection is optimal. The operations can further include comparing one or more predictions with results from executing the request. They may further include adjusting, based on the results, one or more extrapolation factors concerning the request and the hardware location. They may further include quantifying at least one parameter selected from the set of parameters consisting of: cost, power, emissions, latency, and compute loading. Furthermore, they may include comparing the results with a baseline profile.

Another embodiment provides a system including a processor and a memory. The memory includes instructions stored on, which, when executed by the processor cause the processor to perform certain operations. The operations can include receiving a request, the request being associated with a batch process for manipulating a dataset. The operations can further include receiving a deadline by which the request must be executed and evaluating a set of requirements for executing the request by the deadline. The operations can further include entering the request into a queue, where the queue is associated with a hardware location physically hosting the dataset. The operations can further include determining an optimum time within the deadline for executing the request.

The above-disclosed subject matter is to be considered illustrative, and not restrictive, and the appended claims are intended to cover all such modifications, enhancements, and other embodiments that fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

Those skilled in the relevant art(s) will appreciate that various adaptations and modifications of the embodiments described above can be configured without departing from the scope and spirit of the disclosure. Therefore, it is to be understood that, within the scope of the appended claims, the disclosure may be practiced other than as specifically described herein.

What is claimed is:

1. A method residing as instructions on a non-transitory computer-readable medium, the instructions being configured to cause a processor to perform operations comprising:
receiving a request for access to a resource;
determining, based on the request, a usage profile;
executing, based on the usage profile, a search for an available resource corresponding to one or more attributes of the usage profile;
providing access to the available resource in response to finding the available resource;
tracking a plurality of parameters associated with the available resource upon the available resource being used after the providing; and
based on the tracking, (i.) comparing the plurality of parameters to parameters from a baseline profile and (ii.) training a model for the search based on the comparing, the search to be affected using the model upon receiving a subsequent request.

2. The method of claim 1, wherein the available resource is a networked resource.

3. The method of claim 1, wherein providing the available resource includes estimating a likelihood of the available resource being unused for at least a typical usage time included in the usage profile.

4. The method of claim 1, wherein the plurality of parameters includes at least one parameter selected from the set of parameters consisting of: cost, power, emissions, latency, and compute loading.

5. The method of claim 1, wherein the resource is a virtual machine.

6. The method of claim 1, wherein providing the available resource includes selecting the available resource based on a power generation level associated with the available resource.

7. The method of claim 6, wherein the power generation level is an over-power generation level.

8. A system, comprising:
a processor;
a memory including instructions, which when executed, cause the processor to perform operations including:
receiving a request for access to a resource;
determining, based on the request, a usage profile;
executing, based on the usage profile, a search for an available resource corresponding to one or more attributes of the usage profile;
in response to finding the available resource, providing access to the available resource;
tracking a plurality of parameters associated with the available resource upon the available resource being used after the providing; and
based on the tracking, (i.) comparing the plurality of parameters to parameters from a baseline profile and (ii.) training a model for the search based on the comparing, the search to be affected using the model upon receiving a subsequent request.

9. The system of claim 8, wherein the available resource is a networked resource.

10. The system of claim 8, wherein providing the available resource includes estimating a likelihood of the available resource being unused for at least a typical usage time included in the usage profile.

11. The system of claim 8, wherein the plurality of parameters includes at least one parameter selected from the set of parameters consisting of: cost, power, emissions, latency, and compute loading.

12. The system of claim 8, wherein the resource is a virtual machine.

13. The system of claim 8, wherein providing the available resource includes selecting the available resource based on a power generation level associated with the available resource.

14. A non-transitory computer-readable medium having instructions stored thereon, the instructions, when executed, cause a processor to perform a method comprising:
receiving a request for access to a resource;
determining, based on the request, a usage profile;
executing, based on the usage profile, a search for an available resource corresponding to one or more attributes of the usage profile;
in response to finding the available resource, providing access to the available resource;
tracking a plurality of parameters associated with the available resource upon the available resource being used after the providing; and
based on the tracking, (i.) comparing the plurality of parameters to parameters from a baseline profile and (ii.) training a model for the search based on the comparing, the search to be affected using the model upon receiving a subsequent request.

15. The non-transitory computer-readable medium of claim 14, wherein the available resource is a networked resource.

16. The non-transitory computer-readable medium of claim 14, wherein providing the available resource includes estimating a likelihood of the available resource being unused for at least a typical usage time included in the usage profile.

17. The non-transitory computer-readable medium of claim 14, wherein the plurality of parameters includes at least one parameter selected from the set of parameters consisting of: cost, power, emissions, latency, and compute loading.

18. The non-transitory computer-readable medium of claim 14, wherein the resource is a virtual machine.

19. The non-transitory computer-readable medium of claim 14, wherein providing the available resource includes selecting the available resource based on a power generation level associated with the available resource.

20. The non-transitory computer-readable medium of claim 19, wherein the power generation level is an over-power generation level.
